(19) United States
(12) Patent Application Publication
(10) Pub. No.: US 2015/0117158 A1
(43) Pub. Date: Apr. 30, 2015

(54) USING NEAR-FIELD ACOUSTIC SIGNALS TO CONFIGURE END-USER DEVICES

(71) Applicant: Kobo Inc., Toronto (CA)

(72) Inventors: James Wu, Newmarket (CA); Yasuyuki Hayashi, Tokyo (JP)

(73) Assignee: Kobo Inc., Toronto (CA)

(21) Appl. No.: 14/066,278

(22) Filed: Oct. 29, 2013

(51) Int. Cl. G08C 23/02

(52) U.S. Cl. CPC G08C 23/02
USPC 367/197

(57) ABSTRACT

A network service is provided that embeds encodes acoustic data to carry configuration parameters for configuring an end-user device. The network service then transmits or causes transmission of an acoustic signal carrying the configuration parameters to the end-user device. The end-user device detects information items corresponding to configuration parameters embedded in the acoustic data. The end-user device utilizes the configuration parameters in connection with performing select operations.

### TECHNICAL FIELD

Examples described herein relate generally to a system and method for using near-field acoustic signals to configure end-user devices.

### BACKGROUND

There exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system in which an end-user device is configured to access a network service through the use of a near-field acoustic signal, according to an embodiment.

FIG. 2 illustrates an example of an e-reader device for use with one or more embodiments described herein.

FIG. 3 illustrates an example of a server for use with one or more embodiments described herein.

FIG. 4 illustrates an acoustic interface for generating an acoustic configuration file or signal, according to an embodiment.

FIG. 5 illustrates an acoustic interface that can be implemented by an end-user device, according to one or more embodiments.

FIG. 6 illustrates a method for generating an acoustic configuration file from a network service, for use by an end-user device, according to one or more embodiments.

FIG. 7 illustrates a method for an end-user device to receive and process an acoustic configuration file, according to one or more embodiments.

### DETAILED DESCRIPTION

Embodiments described herein provide for transmitting acoustic signals to end-user devices (e.g., e-reader devices, etc.) in order to configure the end-user device. In some embodiments, a network service is provided that structures acoustic data to carry configuration parameters for configuring an end-user device.

According to some embodiments, a network service transmits or causes transmission of an acoustic signal carrying the configuration parameters to an end-user device. The end-user device detects information items corresponding to configuration parameters embedded in the acoustic data. The end-user device utilizes the configuration parameters in connection with performing select operations, such as operations to configure the end-user device for communication with the network service.

According to some embodiments, the acoustic configuration file includes content. In one implementation, the content of the audio configuration file includes music. In a variation, the audio configuration file includes voice, such as a message from a source (e.g., network service) directing instructions or other notification. Still further, in some variations, the audio output from the acoustic configuration file is provided within an in-audio frequency (10 Hz<fs<22.05 kHz). In other variations, the audio output from the acoustic configuration file is provided in an out-of-band frequency range (100 kHz>fs>22.05 kHz).

In an embodiment, a first computer (e.g., server) obtains information associated with an account or with an end-user device. The first computer generates an acoustic configuration file that embeds configuration parameters. The configuration parameters may be based on the information associated with the account or with the end-user device. The acoustic configuration file can be communicated to a destination that is associated with the account. Additionally, the acoustic configuration file can be playable to generate an acoustic signal that conveys the configuration parameters to the end-user device.

In another embodiment, an acoustic signal is received by an end-user device. The acoustic signal may be received through a multi-purpose microphone of the end-user device. One or more configuration parameters embedded in the acoustic signal are detected. The end-user device is configured using the detected configuration parameters.

Still further, an embodiment provides for configuring an end-user device using a first computer. On the first computer, information associated with an account of an end-user device is determined. An acoustic configuration file is generated that embeds one or more configuration parameters as acoustic data. The acoustic configuration file is sent to a designated destination where it can be played or otherwise output for the end-user device. On the end-user device, one or more configuration parameters are determined from an acoustic signal generated by the acoustic configuration file being played back. The end-user device is configured based on the one or more configuration parameters detected from the acoustic signal.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

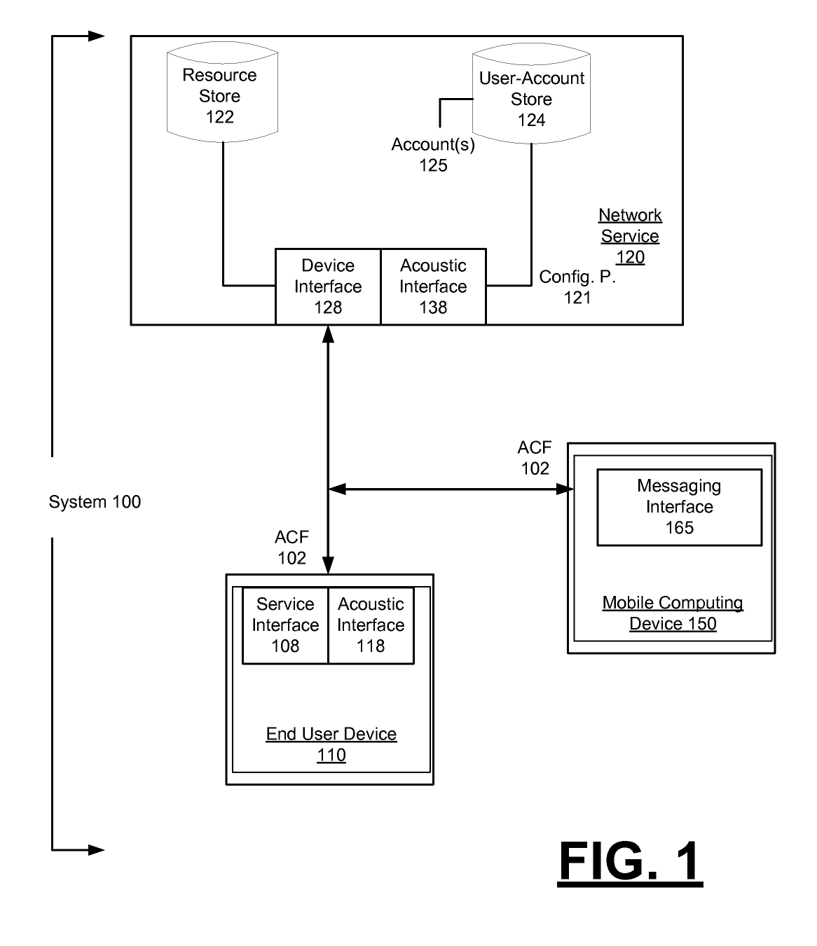

FIG. 1 illustrates a system in which an end-user device is configured to access a network service through the use of a near-field acoustic signal, according to an embodiment. In an example of FIG. 1, system 100 includes an end-user device (e.g., e-reader device 110) that communicates with and utilizes a network service 120 for purpose of receiving, for example, digital content (e.g., e-books) and other resources. According to some embodiments, system 100 is capable of generating acoustic configuration file 102 which can be played back in proximity to the e-reader device 110 for purpose of configuring the end-user device to access and utilize the network service 120. In some variations, system 100 also includes an intermediate computing device (e.g., mobile computing device 150) that acts as an intermediate device to receive the acoustic configuration file 102 from the network service 120, and to playback the acoustic configuration file 102 when in sufficient proximity to the e-reader device 110.

The network service 120 may include multiple servers and other computing resources that provide various services in connection with one or more applications that are installed on the computing device. By way of example, network service 120 can provide e-book services that communicate with an e-book application on the e-reader device 110. The e-book services provided through network service 120 can, for example, include services in which e-books are sold, shared, downloaded and/or stored.

The e-reader device 110 can correspond to any computing device on which applications and application resources (e.g., e-books, media files, documents) can be rendered and consumed. For example, the e-reader device 110 can correspond to a tablet, telephony/messaging device (e.g., smart phone) or portable computing device. In one implementation, for example, e-reader device 110 can run an e-reader application that links the device to the network service 120 and enables e-books provided through the service to be viewed and consumed. In another implementation, the e-reader device 110 can run a media playback or streaming application that receives files or streaming data from the network service 120. In examples described herein, the e-reader device 110 also includes an acoustic input component for receiving a sound generated from the playback of the acoustic configuration file 102. The acoustic input component can correspond to a non-specialized, multipurpose microphone.

By way of example, the e-reader device 110 can be equipped with hardware and software to optimize certain application activities, such as reading electronic content (e.g., e-books). For example, the e-reader device 110 can have a tablet-like form factor, although variations are possible. In some cases, the e-reader device 110 can also have an E-ink display.

In variations in which the mobile computing device 150 is employed as an intermediate device, the mobile computing device 150 can correspond to a tablet, handset or telephony/messaging device (e.g., smart phone) or portable computing device. The mobile computing device 150 can include, for example, resources for establishing network connectivity, as well as the ability to receive messages or otherwise communicate with the network service 120. The mobile computing device 150 can be equipped with an acoustic output component to output encoded near-field acoustic signals to the e-reader device 110. In some variations, the acoustic output component can correspond to non-specialized, mufti-purpose speakers typically employed to output music or other audio content.

In additional detail, the network service 120 can include a device interface 128 and an acoustic interface 138. The device interface 128 communicates with individual devices that access the service. Among other resources, the network service 120 can include a resource store 122 and a user account store 124. The user account store 124 can associate the e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

The acoustic interface 138 of the network service 120 operates to generate the acoustic configuration file 102 for the e-reader device 110. In one implementation, the device interface 128 obtains an identifier of the e-reader device 110, and identifies an account 125 that is associated with the identifier. A set of configuration parameters 121 can be obtained for the account 125. The set of configuration parameters 121 can correspond to, for example, the account identifier, login and password for the identified account, and/or payment information associated with the account. In variations, the set of configuration parameters 121 can also include, for example, preferences of the user, settings of the user account or its devices, and/or identification of resources (e.g., e-books) that the user has downloaded or has permission to download. The acoustic interface 138 encodes the set of configuration parameters 121 into acoustic data, and then packages the acoustic data as the acoustic configuration file 102. The network service 120 can store the acoustic configuration file 102 (e.g., linked with the user account 125), or alternatively store and/or transport the acoustic configuration file 102 to a designated destination. For example, once the acoustic configuration file 102 is generated, the file can be messaged or otherwise communicated to an email address or other network location associated with the account 125 of the e-reader device 110.

As described with examples below, the acoustic configuration file 102 can include audio content, such as music or voice (e.g., message notification). Thus, playback of the acoustic configuration file can result in the user being provided content, while audio transmission communicates configuration parameters to the e-reader device 110.

Once transported, the acoustic configuration file 102 can be played back in proximity to the e-reader device 110 for purpose of configuring that device. In particular, the e-reader device 110 can be configured to utilize the set of configuration parameters 121 to, for example, access and utilize the network service 120. For example, as described in greater detail below, the e-reader device 110 can process acoustic signals received from the playback of the acoustic configuration file 102 in order to detect and process the set of configuration parameters 121. Once configured, the e-reader device 110 can utilize the set of configuration parameters 121 to access and utilize the network service 120.

In variations, the configuration parameters 121 can be provided to the e-reader device 110 for purpose of, for example, triggering the e-reader device 110 to perform diagnostics or corrective processes (e.g., de-bugging). As another variation, data sets and programmatic code can be signaled to the e-reader device 110 to facilitate diagnostic or corrective processes.

According to one aspect, the e-reader device 110 includes programmatic logic corresponding to a service interface 108 and an acoustic interface 118. The service interface 108 can communicate and link that device with the network service 120. The acoustic interface 118 can process acoustic signals received through the microphone of the e-reader device 110 for purpose of detecting information items that are embedded in the acoustic signal. In the example of FIG. 1, the e-reader device 110 identifies information items corresponding to the configuration parameters 121. The service interface 108 can utilize the configuration parameters 121 in order to link or otherwise connect the e-reader device 110 to the network service 120. By way of example, the configuration parameters 121 can enable the service interface 108 of the e-reader device 110 to programmatically specify an account identifier, login, password and/or other parameter when communicating with and accessing the network service 120.

In some variations, the mobile computing device 150 serves as an intermediate device that receives the acoustic configuration file 102, and then play back the acoustic configuration file 102 in proximity to the e-reader device 110. In one implementation, the mobile computing device 150 includes a messaging interface 165. The messaging interface 165 can correspond to, for example, an e-mail application, an instant messaging application, a text message (e.g., Short Message Service) application or other messaging program. The user may have previously stored or otherwise linked a messaging account with the account 125 provided by the network service 120. For example, the user may store an e-mail address with the network service 120. The messaging interface 165 may be used to access the messaging account that is linked to the user's account with the network service 120.

In one implementation, the network service 120 can transport the acoustic configuration file 102 as an email or email attachment to the email account (or other messaging identifier) stored with the particular user's account. The user can access the email with the acoustic configuration file 102 using the mobile computing device 150. In this way, the mobile computing device 150 can playback the acoustic configuration file 102. The user can position the mobile computing device 150 in close proximity to the e-reader device 110 (e.g., within ten feet) so that the output, from playing back the acoustic configuration file 102, is received by the e-reader device 110. Once the acoustic signal is conveyed to the e-reader device 110, the e-reader device implements one or more processes, such as configuration processes, that utilize the conveyed information items (e.g., configuration parameters).

In playing back the acoustic configuration file 102, the mobile computing device 150 may utilize a general purpose speaker. As the e-reader device 110 may utilize a general microphone to receive the acoustic signal from the playback of the acoustic configuration file 102, no specialized hardware components are needed in order to convey the near-field acoustic signal to the e-reader device 110.

As an alternative to the use of the intermediate device (mobile computing device 150), some variations provide for network service 120 to playback the acoustic configuration file 102 for the e-reader device 110. For example, the network service 120 may playback the acoustic configuration file 102 to output an acoustic signal over a telephonic or real-time channel. The user of the e-reader device 110 can position a receiving device (e.g., telephone) next to the e-reader device 110 in order to capture and output the acoustic signal. The e-reader device 110 can then process the received acoustic signal to detect the information items from the acoustic signal.

Hardware Description

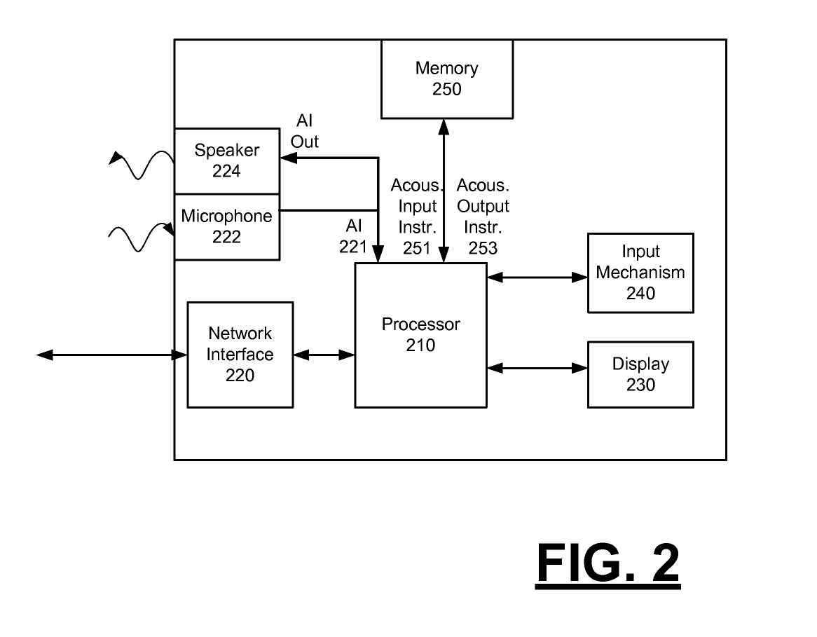

FIG. 2 illustrates an example of an end-user device for use with one or more embodiments described herein. In an example of FIG. 2, the end-user device can correspond to, for example, an e-reader device 200, such as also described by an example of FIG. 1. In the example of FIG. 2, the e-reader device 200 includes a processor 210, a network interface 220, a display 230, one or more input mechanisms 240, and a memory 250. The e-reader device 200 can also include at least one of a microphone 222 or a speaker 224. Each of the microphone 222 or speaker 224 can correspond to a non-specialized, multipurpose component. For example, each of the microphone to 222 speaker 224 can be an “off-the-shelf” component that is manufactured to receive or output sound in a wide variety of acoustic spectrums, including those used to input/output music and/or voice.

In some implementations, the processor 210 utilizes the network interface 220 to communicate with the network service 120 (see FIG. 1). In communicating with the network service 120, the e-reader device 200 can receive application resources 221, such as e-books or media files, that the user elects to purchase or otherwise download from the network service 120. The application resources 221 that are downloaded onto the e-reader device 200 may be stored in the memory 250. In addition to application resources 221, e-reader device 200 can download applications from a variety of sources, including network sources such as network service 120.

The display 230 can correspond to an electronic paper type display, which mimic conventional paper in the manner in which they display content. Examples of such display technologies include electrophoretic displays, electrowetting displays, and electrofluidic displays. Examples described herein further appreciate that the media in which electronic type displays are provided on can vary, and include, for example, plastic or paper combined with transistor elements or other circuitry. In variations, the display 230 can correspond to, for example, a liquid crystal display (LCD) or light emitting diode (LED) display that illuminates in order to provide content generated from processor 210.

According to some embodiments, the memory 250 stores instructions corresponding to at least one of (i) logic 251 for processing encoded acoustic input, and/or (ii) logic 253 for generating encoded acoustic output. In an implementation, the microphone 222 can receive input sound 201 provided from playback of the acoustic configuration file 102 at a sufficiently proximate location (e.g., playback from the mobile computing device 150). The processor 210 implements the acoustic input logic 251 in order to detect configuration parameters and other information items embedded in the input sound 201.

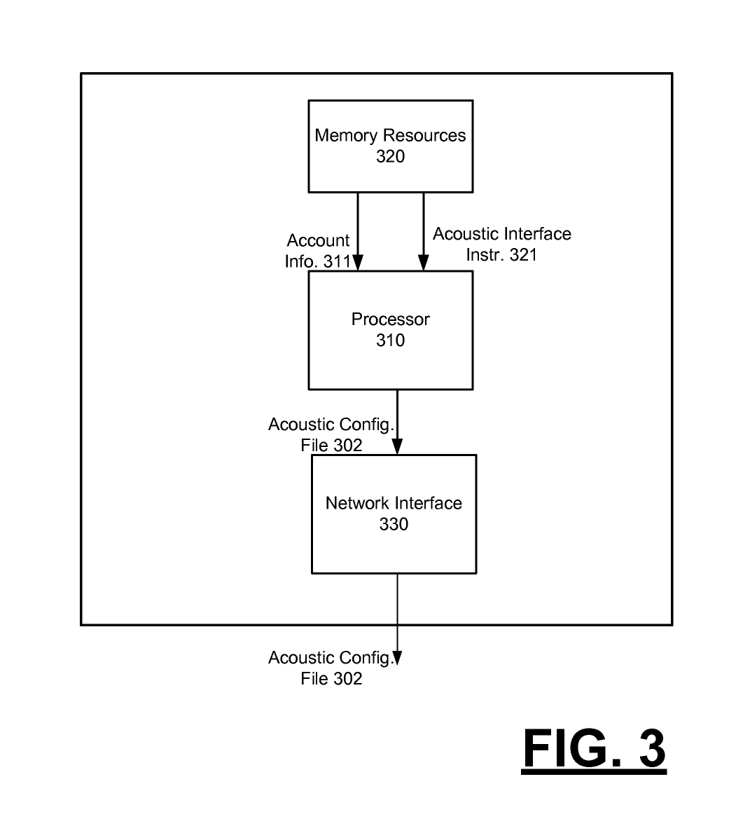

FIG. 3 illustrates an example of a server for use with one or more embodiments described herein. In particular, a server such as described by an example of FIG. 3 can be used to implement a service such as described by an example of FIG. 1. In one embodiment, the server 300 includes a processor 310 (or alternatively, one or more processors), memory resources 320, and a network interface 330. The processor 310 can execute instructions stored with the memory resources 320. Additionally, the processor 310 can communicate with one or more user devices through the network interface 330. In operation, the memory resources 320 store instructions corresponding to acoustic interface 321. The memory resources 320 also provide various data stores, including for example, user account store 124. The processor 310 executes the instructions for the acoustic interface 321 in order to generate the acoustic configuration file 302. The processor 310 may access user account information 311, provided with the user account store 124 (see FIG. 1, shown as being stored in memory resources 320). The user account information can be encoded as configuration parameters and the acoustic configuration file 302. The acoustic configuration file 302 can be communicated to a corresponding end-user devices through the network interface 330.

Acoustic Interface

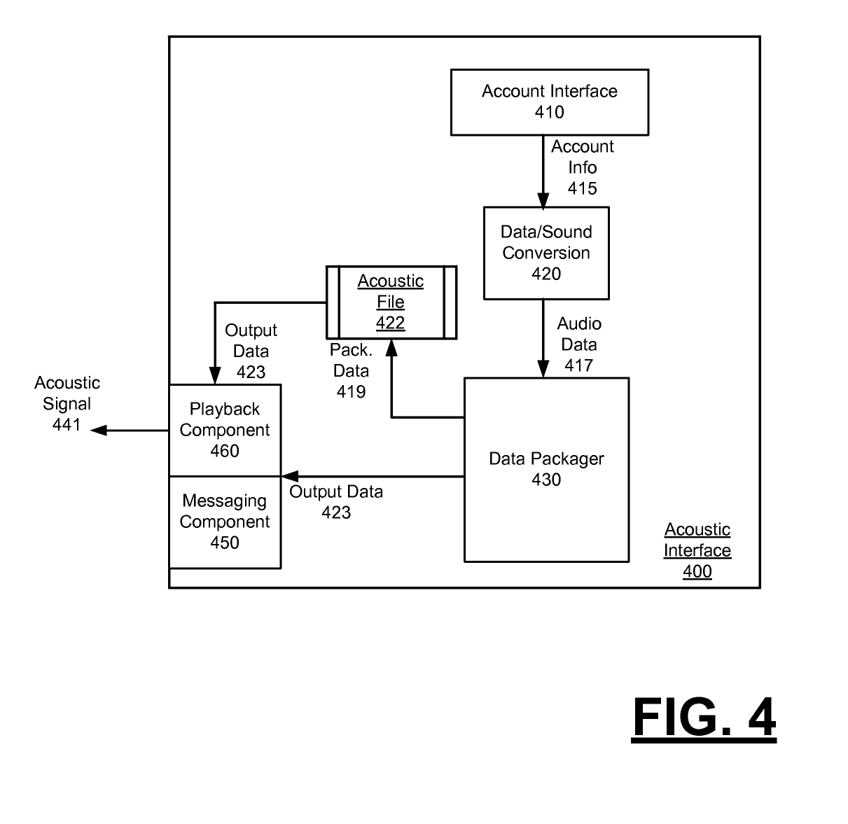

FIG. 4 illustrates an acoustic interface for generating an acoustic configuration file or signal, according to an embodiment. With reference to an example of FIG. 1, the acoustic interface 400 can be implemented as part of the network service 120 (see e.g., acoustic interface 138). Additionally, with reference to an example of FIG. 3, the acoustic interface 400 can be implemented by the processor 310 of the server 300 (for network service 120). In describing an example of FIG. 4, reference may be made to elements of FIG. 1 for purpose of illustrating in operational environment of the acoustic interface 400.

In an embodiment, acoustic interface 400 includes an account interface 410, a data/sound conversion component 420, a data packager 440, and at least one of the playback component 460 and/or messaging component 450. The account interface 410 can retrieve account information 415 based on, for example, an identifier for the e-reader device 110. The identifier can be provided by the user, either operating the e-reader device 110 or by another computing device (e.g., an intermediary computing device such as provided by mobile computing device 150 in the example of FIG. 1). The account information can include, for example, account identifier, login, password, preferences, identifier for a resource associated with the account, payment information (e.g., credit card number), favorite lists, device settings and various other information items, depending on, for example, implementation and application of network services 120.

The data/sound conversion component 420 converts account information 415 into audio data 417. In one implementation, the data/sound conversion component 420 generates frames of data that represent bytes of information corresponding to the account information 415. The audio data 417 can be encoded so as to represent the account information 415, and more specifically configuration parameters identified from the account information. Multiple kinds of encoding techniques can be employed in order to embed the configuration parameters. In particular, the configuration parameters can be encoded as audio data using a spread spectrum technique and/or an electrical water marking technique For example, in one implementation, a modulation technique such as provided by orthogonal frequency-division multiplexing (OFDM) can be used. In variations, the encoding scheme can be provided by a digital water marking technique, including techniques that employ Data Encryption Standard (“DES”) as well as Rivest, Shamir, Adleman (“RSA”) encoding.

Furthermore, in one implementation, configuration parameters can be embedded as an in-audio frequency range (10 Hz<fs<22.05 kHz), such as at approximately 18 kHz. In a variation, the configuration parameters can be embedded as an out-of-band frequency range (100 kHz>fs>22.05 kHz). The acoustic configuration file can further include audio content, such as music or voice (e.g., message or instruction). When the acoustic configuration file 102 includes audio content provided in an out-of-band range, the configuration parameters can be communicated without additional audio noise that would interfere with human listening of the audio configuration file.

The data packager 430 processes the audio data 417 in order to generate acoustic data 419 that is packaged into a file or stream. The packaged acoustic data 419 can be structured or sequence according to a predetermined format and protocol so that individual frames embedded in the acoustic signal carry bits of information. An acoustic configuration file 422 can be generated and/or maintained using the packaged acoustic data 419. In this way, the acoustic configuration file 422 can be generated so that it can be transported electronically to a specified destination, such as to an e-mail address associated with the account of the end-user device.

In one variation, the acoustic interface 400 includes a messaging component 450 that transports the acoustic configuration file 402 to a destination that is associated with an account of the e-reader device 110 (e.g., the user specified e-mail address). For example, the messaging component 450 can include logic to incorporate the acoustic configuration file 402 as an attachment to an email that is addressed to an email address associated with the account.

In another variation, the acoustic interface 400 signals output data 423, either from the acoustic configuration file 422 or directly from the data packager 430, to the playback component 460. The playback component 460 can generate an output acoustic signal 441 that embeds the configuration parameters and information items provided with the output data 423. In one implementation, the playback component 460 can generate an inaudible acoustic signal (e.g., at approximately 20 kHz or more). When the speaker of the e-reader device 110 is positioned in near proximity to the end user computing device, the output acoustic signal 441 of the speaker can be detected and processed by the microphone of the e-reader device 110, in order to determine configuration parameters corresponding to the configuration information. As an example, the user of the e-reader device 110 can access the network service telephonically or through an alternative computing device in order to playback an audio stream corresponding to the output acoustic signal 441.

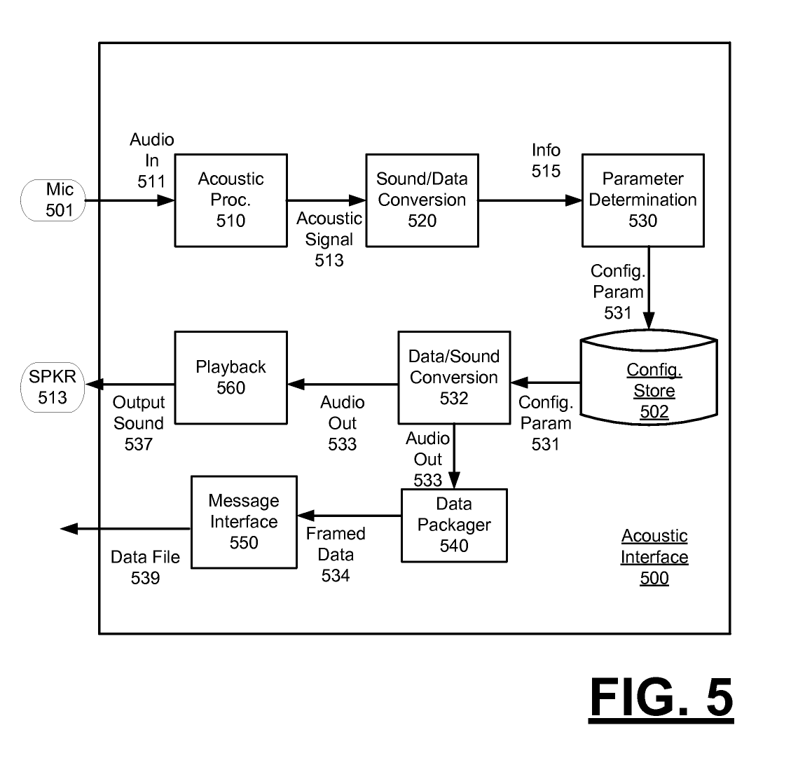

FIG. 5 illustrates an acoustic interface that can be implemented by the e-reader device 110 (see FIG. 1) or other an end-user device. In an example of FIG. 5, the acoustic interface 500 can be operated to receive and process an acoustic input signal that is to configure the e-reader device, according to an embodiment. With reference to an example of FIG. 1, the acoustic interface 500 can be implemented by the e-reader device 110 (see e.g., implemented as acoustic interface 118). Accordingly, reference may be made to elements of FIG. 1 for purpose of illustrating in operational environment of the acoustic interface 500. In one embodiment, the acoustic interface 500 of the e-reader device 110 receives and processes acoustic signals the end that information. In variations, the acoustic interface 500 of the e-reader device 110 is also capable of generating an acoustic signal output to convey information, such as information about the state of the computing device, or configuration information employed on the computing device.

In more detail, the acoustic interface 500 includes an acoustic processing component 510, a sound/data conversion component 520 and a parameter determination component 530. The acoustic processing component 510 receives an acoustic signal input 511 from the microphone 501. In some implementations, the acoustic signal input 511 can be detected from the inaudible acoustic range (e.g., 22.05 kHz to 100 kHz). As mentioned with some other examples, the microphone 501 can correspond to an off the shelf, non-specialized component that can receive any form of acoustic input, including voice input or ambient noise. The acoustic processing component 510 can treat the audio input 511 to identify an acoustic signal 513 that has detectable modulating characteristics (e.g., amplitude or wavelength). The sound/data conversion component 520 can process the acoustic signal 513 in order to determine information bits 515. The parameter determination component 530 can determine a set of configuration parameters 531 from the information bits 515 that are output from the sound/data conversion component 520. This set of configuration parameters 531 can be stored in memory on the e-reader device 110. For example, the configuration store 502 can be maintained as part of the acoustic interface 500.

In some embodiments, the acoustic interface 500 can both generate and receive acoustic signals. More specifically, the acoustic interface 500 can generate acoustic data that encodes information items stored on the device. Examples of information items that can be encoded into acoustic data on the e-reader device 110 can include the current configuration settings of the device (e.g., stored account information such as login or password, network settings, etc.), identification of content items stored on the device, and are output results from execution of a configuration are troubleshooting process.

In order to generate an acoustic output signal 551, the acoustic interface 500 of the e-reader device 110 can include a data/sound conversion component 532, a data packager 540, a messaging interface 550 and/or a playback component 560. The data/sound conversion component 532 can convert stored information items into acoustic output data 533. The stored information items 531 can include configuration parameters 531 stored in, for example, configuration store 502. As an alternative or addition, the data/sound conversion component 532 can convert information items corresponding to, for example, device settings, content library information (e.g., e-books stored in the user device), activity log, and messages (e.g., acknowledgments, confirmation that an activity was performed). Still further, other examples of such information items can include data sets stored by the user, identification the devices that are paired with the e-reader device 110, and various other kinds of information.

In some embodiments, the acoustic output data 533 is provided to the playback component 560, where it is output as an acoustic transmission 537. The transmission can be in the form of an acoustic signal that is inaudible to humans. In one implementation, the acoustic transmission can be output through a speaker 513. As with the microphone 511, the speaker 513 can be a standard, non-specialized component, capable outputting music or voice. The acoustic transmission 537 can be output in proximity to a receiving source, which can detect acoustic transmission 537 and act on it. In one implementation, the acoustic transmission 537 is provided to the mobile computing device 150 (see FIG. 1), which in turn can (i) process the acoustic transmission 537 for information items, and/or (ii) package acoustic transmission 537 into a data file and then transmit the data file as a message over a given transport to network service 120 (or some other location). More specifically, by way of example, the mobile computing device 150 can message the acoustic transmission 537 to the network service 120, and the network service 120 can store the information items (results of diagnostic tests, configuration information, activity log, content library information, etc.) with the user's account. Alternatively, the mobile computing device 150 can store information items that are determined from the acoustic transmission 537 for use with the e-reader device 110 at a subsequent time.

Still further, in some embodiments, the acoustic output data 533 is provided to a data packager 540. The data packager 540 can frame the acoustic output data 522, and communicate framed acoustic data 534 to a messaging interface 550. The messaging interface 550 can correspond to a programmatic interface for a messaging application (not shown in FIG. 5) that is installed on the e-reader device 110. Alternatively, the messaging interface 550 can correspond to messaging transport that is integrated with the acoustic interface 500. The framed acoustic data 534 can then be converted into a data file 539 of a given format and protocol. The data file 539 can be transported via the messaging interface 550 to one or more messaging locations. For example, the data file 539 can be transported as an attachment to an email to an address associated with network service 120.

Methodology

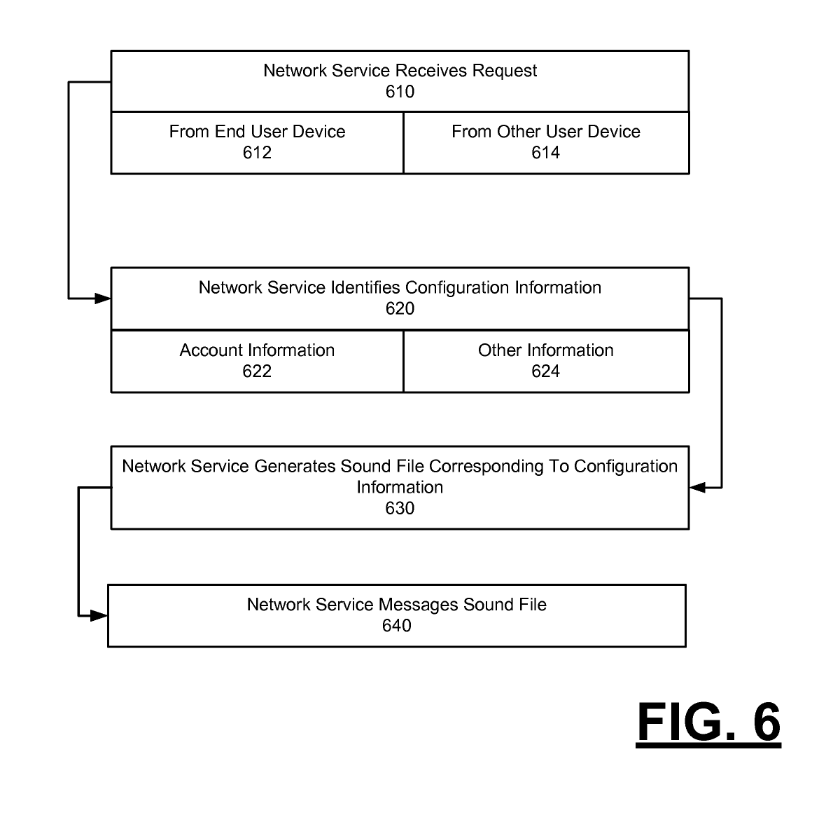

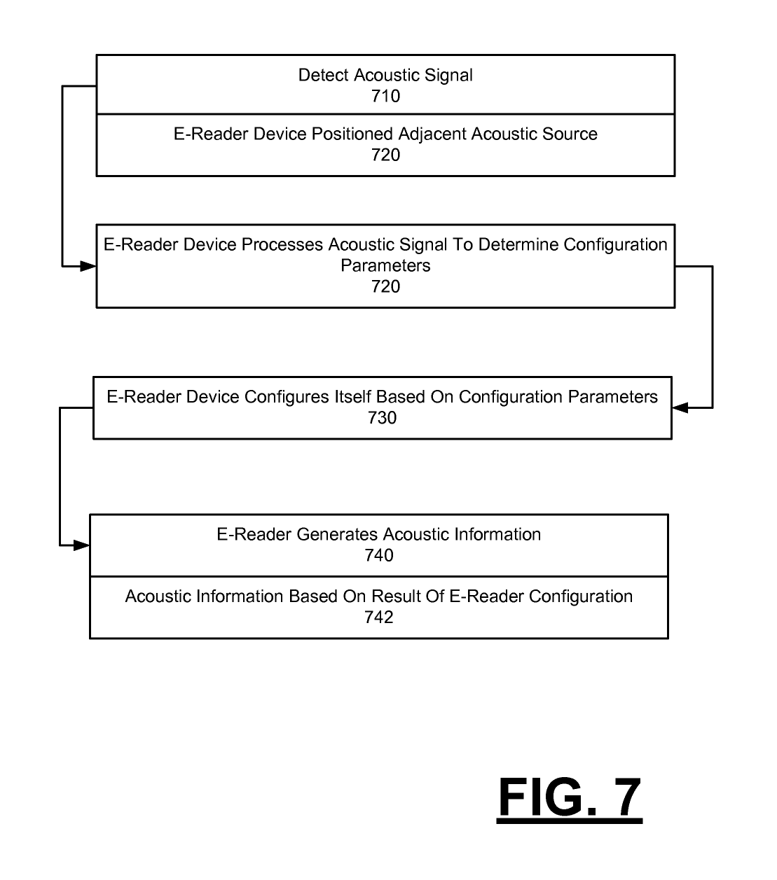

FIG. 6 illustrates a method for generating an acoustic configuration file from a network service, for use by an end-user device (e.g., e-reader device 110), according to one or more embodiments. FIG. 7 illustrates a method for an end-user device (e.g. e-reader device 110) to receive and process an acoustic configuration file, according to one or more embodiments. Examples such as described with FIG. 6 and FIG. 7 may be implemented using components such as described with FIG. 1 through FIG. 5. Accordingly, reference may be made to elements of FIG. 1 through FIG. 5 for purpose of illustrating suitable components for performing a step or sub step being described.

With reference to FIG. 6, network service 120 receives a request to provide configuration parameters for an end-user device (e-reader device 110) (610). The request can specify an account (e.g., user login or password, device identifier). Alternatively, the request may identify that e-reader device 110 as requiring a new account. The request may be received from the e-reader device itself (612). Alternatively, the request may be provided from an intermediate device (e.g., mobile computing device 150) (614). Still further, in some cases such as when the e-reader device 110 is a new device, the user may make the request telephonically (e.g., user calls help center) or through a verbal request (e.g., user is in store).

The network service 120 identifies a set of configuration parameters for the e-reader device, based on an account or other identifier associated with that device (620). For example, if the e-reader device 110 is associated with an existing account (622), the network service may identify configuration parameters for the particular account. If, however, the e-reader device 110 is not associated with an account (e.g., new or out-of-box), the network service 120 may retrieve configuration parameters for a new device (624). Thus, depending on implementation and/or usage, the configuration parameters can be selected for the particular device or account, or a characterization or classification of the device (e.g., new device).

The network service 120 can generate the acoustic configuration file 102 based on the selected set of configuration parameters (630). For example, the acoustic interface 400 (FIG. 4) can be implemented with network service 120 in order to generate the acoustic configuration file 102, encoded to include the set of configuration parameters.

In one implementation, configuration parameters can be embedded as an in-audio frequency range (10 Hz<fs<22.05 kHz). In a variation, the configuration parameters can be embedded as an out-of-band frequency range (100 kHz>fs>22.05 kHz). The acoustic configuration file can further include audio content, such as music or voice (e.g., message or instruction). When the acoustic configuration file 102 includes audio content provided in an out-of-band range, the configuration parameters can be communicated without additional audio noise that would interfere with human listening of the audio configuration file.

Multiple kinds of encoding techniques can be employed in order to embed information such as configuration parameters in the acoustic configuration file. In particular, the configuration parameters can be encoded as audio data using a spread spectrum technique and/or an electrical water marking technique For example, in one implementation, a modulation technique such as provided by orthogonal frequency-division multiplexing (OFDM) can be used. In variations, the encoding scheme can be provided by a digital water marking technique, including techniques that employ DES or RSA encoding.

The network service 120 then messages that acoustic configuration file 102 to a location associated with the account or user (640). For instances when the e-reader device 110 is associated with an existing account, the network service 120 can send the acoustic configuration file 102 an e-mail of or other messaging location provided with the identified account. For instances when the e-reader device 110 is, for example, an out-of-the-box device, the user can be prompted to provide a messaging location when making the request. For example, the user may call a help center and request assistance. If no account is associated with the particular device that is to be configured, the user may be prompted to provide an email address where the acoustic configuration file 102 can be transmitted.

With reference to FIG. 7, an e-reader device 110 detects an acoustic signal (710). The acoustic signal can be generated from another computer playing the acoustic configuration file 102 in proximity to that e-reader device's microphone. In one implementation, an intermediate device (e.g., mobile computing device 150) places the acoustic configuration file 102 in proximity to the e-reader device 110. In variations, the network service 120 can generate and communicate the acoustic signal telephonically. For example, the user may place a handset receiver adjacent to an e-reader device 110 during an active call (e.g., initial set up call, trouble shooting call) in order for the network service 120 to output the acoustic signal that is detected by the e-reader device.

Once the acoustic signal is detected by the e-reader device 110, the e-reader device 110 processes the acoustic transmission in order to identify a set of configuration parameters or other information items (720). For example, the e-reader device 110 can employ the acoustic interface 500 in order to process the incoming acoustic signal and determine configuration parameters.

The e-reader device 110 uses the set of configuration parameters to configure itself (730). As mentioned with other examples, the configuration parameters can, for example, enable the e-reader device to obtain, for example, user account information that can be used by the device to automatically access the network service 120. Thus, for example, the configuration parameters can provide the account login and password, credit card information, device identifier or other information needed for the e-reader device to access the network service 120 (or other network service). As an alternative or variation, the configuration parameters can correspond to device settings or datasets that are implemented by processing resources in order update or trouble shoot the e-reader device.

In some embodiments, the end-user device (e-reader device 110) generates and outputs acoustic information that identifies information stored are otherwise provided on the end-user device (740). For example, the e-reader device 110 can generate an acoustic signal that includes information confirming receipt of the acoustic configuration file 102. Still further, in some variations, the e-reader device 110 can communicate a response or result from implementing a configuration process. For example, the e-reader device 110 can implement a configuration (or diagnostic) process using configuration parameters communicated in the acoustic configuration file 102, then communicate information resulting from performance of the configuration process through acoustic information that is outputted to an intermediate device via the speaker of the e-reader device 110. In such an implementation, the e-reader device receives the acoustic configuration file 102 through a microphone, and then generates resulting acoustic information through the speaker of the device. An intermediate device (e.g., mobile computing device 150) can be used to transmit the acoustic configuration file 102 and to receive acoustic information generated from the e-reader device 110. In this way, the e-reader device can generate acoustic information in order to inform the network service 120 or other entity of a result of the configuration process (742). Such an output can assist, for example, the implementation of troubleshooting steps, where a user is attempting to configure his e-reader device with the help of the remote help center.

In some variations, the e-reader device 110 can communicate, as acoustic information, a set of configuration parameters using the acoustic signal. For example, the e-reader device 110 can generate the acoustic signal to communicate to an intermediate device (e.g., mobile computing device 150). The configuration parameters can be stored on mobile computing device 150 for later use. For example, the e-reader device 110 can subsequently retrieve configuration parameters from an intermediate device (e.g., mobile computing device 150, which may be paired to the e-reader device 110), rather than the network service 120. In some variations, the mobile computing device 150 can communicate stored sets of configuration parameters to the e-reader device 110 as an acoustic transmission. Thus, the e-reader device 110 can signal acoustic output data that is captured by the intermediate device and stored in a native or acoustic form for later playback to the e-reader device as needed.

### Usage Examples

Embodiments recognize that on occasion, the purchase of a new device (e.g., e-reader device 110) can be a problematic phase with regards to establishing such devices for ongoing use for a particular user. With regard to the e-reader devices, for example, such devices are often linked to the network service from which e-books can be downloaded. Moreover, the functionality of such devices is significantly limited if the device cannot access the network service from where e-books (or other digital content items) can be downloaded or purchased. Thus, for example, the inability of the user to establish network connectivity, or establish a new account can significantly hinder the user's out-of-box enjoyment of the new device. Conversely, when such users seek help, conventional approaches can sometimes be problematic. If the user is unable to access a network and/or is unable to access a necessary network service, the ability of the manufacturer or provider to remotely troubleshoot the device is also limited.

Among other benefits, examples described herein, on the other hand, enable users to perform configuration processes to achieve network connectivity and/or access to the network service using resources that are typically available to any user. Additionally, the acts required of the user can be significantly simpler to perform than more conventional approaches. Under conventional approaches, for example, the user sometimes has to enter various network settings and/or account information when the user may have little familiarity with what is needed.

In some embodiments, the user can place a phone call to the help center (e.g., technical assistance line), then provide the help center with an e-mail address. The help center can determine configuration parameters for the user end-device, and then programmatically generate the acoustic configuration file 102. The user can then place the telephone handset adjacent to the device that is to be configured. The network service can output the acoustic transmission over the telephone line, and the placement of the e-reader adjacent to the output of the telephone line enables the e-reader device to receive the transmission through its microphone. Upon receiving the acoustic transmission, the e-reader device 110 can configure itself with necessary information such as network service login and password, so that the user is able to access the network service.

Additionally, in some variations, the e-reader device 110 can implement diagnostic or corrective processes in order to assist the help center with troubleshooting. For example, the acoustic transmission provided from the help desk can provide a data set that triggers the e-reader to execute a diagnostic process. Furthermore, the e-reader device 110 can return an acoustic response that can be communicated through the telephonic channel to the network service 120. The acoustic transmission returned from the e-reader device 110 can include information relating to the result of the diagnostic or corrective process. In this way, the e-reader device 110 can be configured, diagnosed, or corrected with transmission of acoustic signals.

As another usage example, rather than generate the acoustic transmission from the network service 120, the network service 120 can package the acoustic configuration file 102 as an attachment to a message. The message can be communicated to an email address provided by the user. The user can operate an intermediate device, such as their mobile handset, to output the acoustic configuration file 102 in proximity to the e-reader device 110. In turn, the e-reader device 110 can configure itself with configuration parameters and other information items embedded in the acoustic transmission.

Alternatives or Variations

As an alternative or variation, an audio configuration file such as described with various examples herein can be provided in the form of a media file. Thus, for example, audio-visual content can include acoustic configuration parameters that are detectable to, for example, an end-device. A user can playback the media file to receive audio/video content on, for example, the mobile computing device 150, while at the same time, the user can have the e-reader device detect and process configuration parameters in the detectable audio signal. As mentioned in some other examples, the encoding of the audio signal can use either in-audio-range or out-of-audio range frequencies.

In variations, the mobile computing device 150 can output video content that includes visual encoding. For example, the display of the mobile computing device 150 can output visual encoding, and a camera component of the e-reader device can detect codes embedded in the visual output. The visual encoding scheme can utilize, for example, still images, moving pictures, or QR codes. In particular, the camera can detect visual information that can be processed for configuration parameters.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for configuring an end-user device, the method being implemented by one or more processors and comprising:
(a) obtaining information associated with an account or with the end-user device;
(b) generating an acoustic configuration file that embeds configuration parameters that are based on the information associated with the account or with the end-user device; and
(c) communicating the acoustic configuration file to a destination that is associated with the account, the acoustic configuration file being playable to generate an acoustic signal that conveys the configuration parameters to the end-user device.

2. The method of claim 1, wherein communicating the acoustic configuration file includes sending the acoustic configuration file as a message to a messaging destination associated with the account.

3. The method of claim 1, wherein obtaining information includes obtaining one or more information items stored as part of the account, the one or more information items corresponding to at least one of an account login, an account password, or credit card number provided for the account.

4. The method of claim 1, wherein obtaining information includes obtaining device information for performing one or more of (i) reconfiguring the end-user device, (ii) running a diagnostic process on the end-user device, and (iii) implementing a corrective programmatic process on the end-user device.

5. The method of claim 1, wherein (a) through (c) are performed on a server as part of a network service.

6. The method of claim 1, wherein at least one of (a), (b), or (c) is performed on an intermediate device that is associated with the account or with the end-user device.

7. The method of claim 1, wherein (b) includes incorporating audio content into the acoustic configuration file, the audio content corresponding to at least one of music or voice message.

8. The method of claim 1, wherein (b) includes encoding the configuration parameters using a spread spectrum technique and/or an electrical water marking technique.

9. A method for configuring an end-user device, the method being implemented by one or more processors and comprising:
receiving an acoustic signal through a mufti-purpose microphone of the end-user device;
detecting one or more configuration parameters embedded in the acoustic signal; and
configuring the end-user device using the detected configuration parameters.

10. The method of claim 9, wherein the configuration parameters include one or more of an account identifier, a login, a password, and/or payment information, and wherein configuring the end-user device includes configuring the end-user device to programmatically access and utilize a network service, the end-user device automating use of one or more the configuration parameters in enabling the end-user device to access and utilize the network service.

11. The method of claim 9, wherein the configuration parameters include one or more setting or diagnostic parameters, and wherein configuring the end-user device includes enabling the end-user device to implement one or more corrective or diagnostic programmatic processes, the end-user device automating use of one or more of the configuration parameters in running a diagnostic or corrective programmatic process.

12. The method of claim 9, further comprising:
generating an acoustic information file that identifies information on the end-user device after the end-user device is configured, and
playing back the acoustic information file through a general purpose speaker of the end-user device so that an acoustic signal is generated and detected by an intermediate device.

13. The method of claim 12, further comprising:
generating an acoustic information file that identifies information on the end-user device after the end-user device implements the one or more corrective or diagnostic programmatic processes, and
playing back the acoustic information file through a general purpose speaker of the end-user device so that an acoustic signal is generated and detected by an intermediate device.

14. A method for configuring an end-user device, the method being implemented by one or more processors and comprising:
on a first computer:
determining information associated with an account of an end-user device;
generating an acoustic configuration file that embeds one or more configuration parameters as acoustic data;
sending the acoustic configuration file to a designated destination;
on the end-user device:
detecting the one or more configuration parameters from an acoustic signal generated by the acoustic configuration file being played back from the designated destination; and
configuring the end-user device based on the one or more configuration parameters detected from the acoustic signal.

15. The method of claim 14, wherein the configuration parameters correspond to account parameters for linking to end-user device to an account provided by a network service, and wherein configuring the end-user device includes configuring the end-user device to automatically signal, in response to a given event, the account parameters to the network service in order to enable the end-user device to access and utilize the network service.

16. The method of claim 15, wherein the account parameters correspond to one or more of an account identifier, a login, a password, and/or payment information.

17. The method of claim 14, wherein the one or more configuration parameters include one or more setting or diagnostic parameters, and wherein configuring the end-user device includes enabling the end-user device to implement one or more corrective or diagnostic programmatic processes, the end-user device automating use of one or more the configuration parameters in running a diagnostic or corrective programmatic process.

18. The method of claim 14, wherein the designated destination corresponds to a messaging destination accessible to an intermediate device of a user, and wherein the method further comprises playing back the acoustic configuration file from the intermediate device.

19. The method of claim 14, wherein the first computer corresponds to a server that is provided as part of a network service, and wherein sending the acoustic configuration file includes sending the acoustic configuration file to a messaging destination that is associated with the account of the end-user.

20. The method of claim 19, wherein sending the acoustic configuration file includes sending the acoustic configuration file as an attachment to a message addressed to the messaging destination.

21. The method of claim 14, further comprising:
outputting an acoustic signal through a general purpose speaker of the end-user device, so that the acoustic signal is generated and detected by an intermediate device that identifies information on the end-user device after the end-user device is configured.

22. The method of claim 21, wherein outputting the acoustic data includes embedding information resulting from configuring the end-user device into acoustic data, and packaging acoustic data as a file that is stored on the end-user device.
